(19) United States
(12) Patent Application Publication
(10) Pub. No.: US 2012/0269358 A1
(43) Pub. Date: Oct. 25, 2012

(54) ACTIVE SOUND CONTROL

(75) Inventors: Robert Gee, Lake Barrington, IL (US); Shafer Seymour, Bartlett, IL (US)

(73) Assignee: CONTINENTAL AUTOMOTIVE SYSTEMS, INC., Deer Park, IL (US)

(21) Appl. No.: 13/091,837

(22) Filed: Apr. 21, 2011

(51) Int. Cl. G10K 11/16

(52) U.S. Cl. 381/71.4

(57) ABSTRACT

An apparatus for controlling sound within a vehicle includes an acoustical damping device operable to determine a measured sound. The acoustical damping device is operable to output a noise canceling signal to a vehicle audio system to dampen the measured sound. A sound controller is operably coupled to the acoustical damping device and is configured to automatically receive an environment signal from an environment sensor. The sound controller is configured to determine an operating mode of the vehicle based on the environment signal. The operating mode is selectable from an operating mode list that includes a stress operating mode and a calm operating mode. The sound controller is configured to cause alteration of the noise canceling signal and reduction in damping in the stress operating mode with respect to the calm operating mode.

### FIELD OF THE INVENTION

This invention generally relates to a system for the active control of sound within motor vehicles.

### BACKGROUND

Occupants of a motor vehicle typically hear many sounds, including sounds originating outside of the vehicle, such as nearby airplanes, automobiles, and trains, and sounds created by the vehicle, including road noise, sounds made by the vehicle powertrain, and other vehicle component sounds. Some vehicles include sound dampening systems that are designed to change the effect of the overall sound environment in the vehicle, typically by dampening some of the various sounds heard by a driver and/or passengers.

In some vehicles, the dampening systems provide a noise canceling signal to reduce the noise heard within a vehicle. These systems may be preset by a manufacturer or supplier to achieve a desired amount of sound dampening within the vehicle. Although such dampening systems may provide a relatively quiet and comfortable environment within a vehicle, such an environment may not be desirable under certain circumstances. For example, when driving conditions are difficult, the sound dampening system may hinder the driver's ability to drive safely by masking road noise which would otherwise provide the driver with more alertness.

### SUMMARY

The system and apparatus described herein utilizes an active sound dampening system to improve driver awareness and driving safety, based on inputs that may include external sensor detection. Two drivers on the same road can have very different perceptions of the roadway environment, based on the sounds in the vehicle cabin. One driver, in a soft-suspension, quiet luxury vehicle, may have the perception of driving slowly along a relatively smooth, straight road. The other driver, in a low-to-the-ground (short-ride suspension) economy vehicle with poor sound insulation, may have the perception that he/she is moving quickly over a slightly rough roadway. Although the quiet and comfort of the luxury vehicle may be desirable at times, under poor driving conditions, quiet may not be desirable because the driver may not notice the speed of travel or may not pay full attention to the driving task. Therefore, when appropriate, the vehicle system may change the level of sound damping or add sounds to induce a certain “feel” to the audio environment within the vehicle.

An apparatus for controlling sound within a motor vehicle is provided. The apparatus includes an acoustical damping device operable to determine a measured sound within the vehicle. The acoustical damping device is operable to output a noise canceling signal to a vehicle audio system to dampen the measured sound. The apparatus further includes a sound controller operably coupled to the acoustical damping device. The sound controller is configured to automatically receive an environment signal from an environment sensor and determine an operating mode of the vehicle based on the environment signal. The operating mode is selectable from an operating mode list that includes a stress operating mode and a calm operating mode. The sound controller is configured to cause alteration of the noise canceling signal and a reduction in damping in the stress operating mode, and the sound controller is configured to refrain from altering the noise canceling signal and refrain from reducing damping in the calm operating mode.

In certain implementations, an apparatus for controlling sound within a motor vehicle includes at least three operating modes. As such, an acoustical damping device is provided, which is operable to determine a measured sound within the vehicle. The acoustical damping device is operable to output a noise canceling signal to a vehicle audio system to dampen the measured sound. A sound controller is operably coupled to the acoustical damping device and to a vehicle entertainment system. The sound controller is configured to automatically receive an environment signal from an environment sensor and determine an operating mode of the vehicle based on the environment signal. The operating mode is selectable from an operating mode list that includes a high-stress operating mode, a mild-stress operating mode, and a calm operating mode.

In the high-stress operating mode, the sound controller is configured to eliminate the noise canceling signal and eliminate damping and cause the acoustical damping device to generate an atonal signal. The atonal signal is configured to cause an atonal sound to raise driver awareness. In the high-stress operating mode, the sound controller is further configured to generate a signal to the vehicle entertainment system that will lower the volume of existing sound from the entertainment system playing over vehicle speakers and play an alert message over the vehicle speakers.

In the mild-stress operating mode, the sound controller is configured to cause alteration of the noise canceling signal and a reduction in damping. In the calm operating mode, the sound controller is configured to refrain from altering the noise canceling signal and refrain from reducing damping. The environment sensor(s) may include any one or combination of the following items: an external object detector, a rough road detector, a camera, a global-positioning-system (GPS) device, a radar detector, a speed sensor, a traffic sensor, and/or a driver drowsiness sensor.

In some implementations, a sound control system is provided for controlling sound within a motor vehicle. The sound control system includes an environment sensor operable to measure a parameter of the environment and output an environment signal. A sound controller is operably coupled to the environment sensor, and the sound controller is configured to automatically receive the environment signal and determine an operating mode of the vehicle based on the environment signal. The operating mode is selectable from an operating mode list that includes at least a stress operating mode and a calm operating mode. An acoustical damping device is operably coupled to the sound controller and is operable to determine a measured sound within the vehicle. The acoustical damping device is operable to output a noise canceling signal to dampen the measured sound. A vehicle audio system is provided that is operable to receive the noise canceling signal from the acoustical damping device and emit the noise canceling sound to dampen noises within the vehicle. The sound controller signal is configured to cause alteration of the noise canceling signal and a reduction in damping in the stress operating mode, and the sound controller is configured to refrain from altering the noise canceling signal and refrain from reducing damping in the calm operating mode.

In some implementations, a method of controlling sound within a motor vehicle to increase driver awareness during certain driving conditions is provided. The method includes determining a measured sound within a vehicle, generating a noise canceling signal to a vehicle audio system to dampen the measured sound, automatically receiving an environment signal from an environment sensor, and determining an operating mode of the vehicle based on the environment signal. The operating mode is selectable from an operating mode list that includes a stress operating mode and a calm operating mode. In the stress operating mode, the method includes altering the noise canceling signal and reducing damping. In the calm operating mode, the method includes refraining from altering the noise canceling signal and refraining from reducing damping.

In still another implementation, a machine-readable medium that provides instructions is provided, which when executed by a machine, cause the machine to perform operations. The operations include determining a measured sound within a vehicle, generating a noise canceling signal to a vehicle audio system to dampen the measured sound, automatically receiving an environment signal from an environment sensor, and determining an operating mode of the vehicle based on the environment signal. The operating mode is selectable from an operating mode list that includes at least a stress operating mode and a calm operating mode. In the stress operating mode, the operations include altering the noise canceling signal and reducing damping.

In the calm operating mode, the operations include refraining from altering the noise canceling signal and refraining from reducing damping.

### BRIEF DESCRIPTION OF THE DRAWINGS

Example embodiments of the invention are reflected in the drawings and will be described below. The drawings show:

FIG. 1 is a side view of a representative motor vehicle;

FIG. 2 is a schematic diagram of a sound control system, including an apparatus for controlling sound;

FIG. 3 is a process step diagram of a method for controlling sound; and

FIG. 4 is a schematic diagram of a computer system that may be used for controlling sound.

### DETAILED DESCRIPTION

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple,” “couples,” “coupled,” or “coupleable” are intended to mean either an indirect or direct electrical or wireless connection. Thus, if a first device couples to a second device, that connection may be through a direct electrical, optical, wireless connection, etc., or through an indirect electrical, optical, wireless connection, etc. by means of other devices and connections.

One or more embodiments of the invention are described below. It should be noted that these and other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

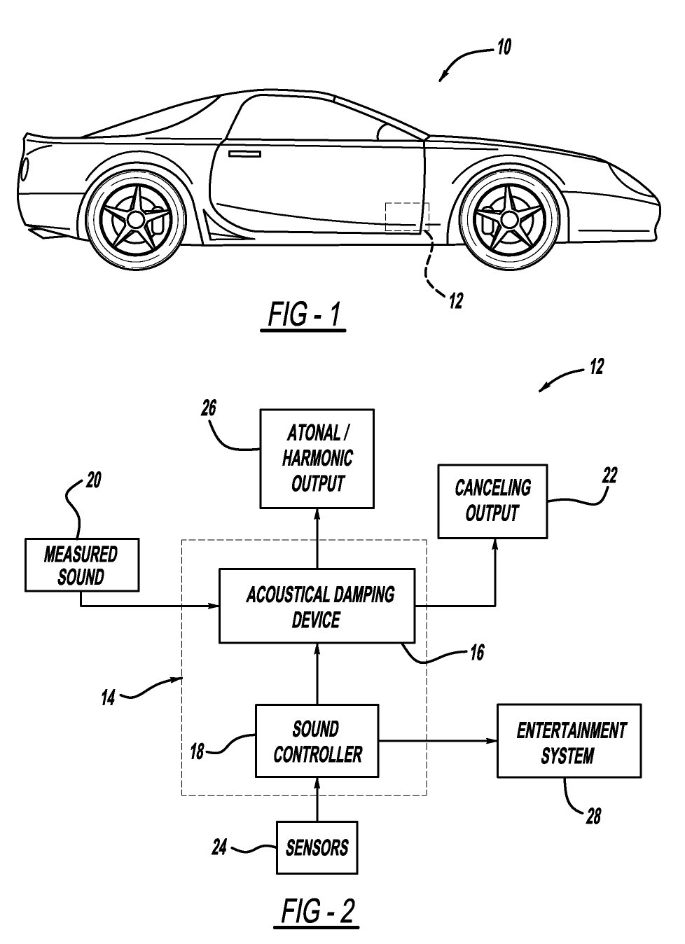

A representative motor vehicle 10 is shown in FIG. 1, including a sound control system 12. Now with reference to FIG. 2, a schematic representation of the sound control system 12 is illustrated. The sound control system 12 includes an apparatus for controlling sound 14, which may include an acoustical damping device 16 and a sound controller 18.

The acoustical damping device 16 is operable to gather a measured sound signal 20 and output a noise canceling output 22 to a vehicle audio system to dampen the measured sound 20. The acoustical damping device 16 could measure the sound directly, or collect a measured sound signal from another device, without falling beyond the spirit and scope of the present invention. The vehicle audio system could include vehicle speakers associated with a vehicle entertainment system, or the vehicle audio system could be designed for use with the acoustical damping device 16 without being part of the vehicle entertainment system.

More particularly, the acoustical damping device 16 drives a speaker to generate a noise canceling output 22 that operates to attenuate or cancel sounds that are present within a vehicle, such as engine noise, noise from other vehicle components, road noise, or other outside noises. The acoustical damping device 16 may operate using the principles of phase cancellation, by generating a noise canceling output 22 that matches the sound amplitude of the measured sound 20 with a sound wave of the opposite polarity, to cancel or reduce the measured sound 20, which may include the background or operating noises within the vehicle or sounds originating from outside the vehicle. It should be understood that any type of acoustical damping device 16 could be used, without falling beyond the spirit and scope of the present invention.

The sound controller 18 is operably coupled to the acoustical damping device 16. In this embodiment, the sound controller 18 and the acoustical damping device 16 are shown as two separate elements, but it should be understood that they could be housed within the same control unit, such that a single controller accomplishes the functions of both elements. An environment sensor 24 detects an environmental condition and sends a signal to the sound controller 18. The environment sensor 24 could be an external object detector, a rough road detector, a camera, a global-positioning-system (GPS) device, a radar detector, a speed sensor, a traffic sensor, and/or a driver drowsiness sensor, by way of example. The sound controller 18 may be configured to automatically receive an environment signal from the environment sensor 24. In other words, in some embodiments, the sound controller 18 collects the environment signal without any input from a person.

Based on the environment signal from the environment sensor 24, the sound controller 18 determines an operating mode of the vehicle 10. The operating mode may be selected from an operating mode list that includes a stress operating mode and a calm operating mode. In some embodiments, the operating mode list could also include a high-stress operating mode, which will be described in further detail below.

In embodiments that include only two operating modes, the operating modes could be labeled as the stress operating mode and the calm operating mode. In the stress operating mode, the sound controller 18 could be configured to cause alteration of the noise canceling output 22 and a reduction in damping. The noise canceling output 22 could be reduced, changed, or eliminated in the stress operating mode, in order to put the driver into an alert mood and increase the safety of driving. In the calm driving mode, the sound controller 18 could be configured to refrain from altering the noise canceling output 22 and refrain from reducing damping. Thus, the acoustical damping device 16 could provide a full noise canceling output 22 in the calm driving mode.

In some embodiments, the sound controller 18 could cause the acoustical damping device 16 to output an atonal or harmonic output 26 in the stress operating mode. The atonal or harmonic output 26 could increase the vehicle noise by making the noise atonal or causing a resonant noise or higher volume of noise to be emitted, to make the vehicle noise more noticeable to the driver. In other words, the atonal or harmonic output 26 could change the timbre or equalization of the noise within a vehicle to strengthen the noise or cause the noise to sound off-key. As a result, uncomfortable, atonal, or louder sounds will be provided to the driver, and he/she may pay more attention to his/her driving. In response to the atonal or harmonic output 26, the driver may feel more tense, which may improve his/her attention when approaching a dangerous area, for example. Thus, in the stress driving mode, the dampening effect can be decreased and the sound control system 12 could add harmonic or atonal sounds to subliminally change the driver's perception of the in-vehicle environment.

One environment sensor 24 that may provide input to the sound controller 18 may include an external object detector. If the external object detector detects an object that requires heightened attention, the sound controller 18 may activate the stress operating mode, or a high-stress operating mode, to alert the driver. In the alternative, if the external object detector detects nothing, then the sound controller 18 would not activate a stress operating mode, and instead, the sound controller 18 may activate the calm driving mode, if no other environment sensors 24 cause the stress or high-stress operating modes to be selected.

Another environment sensor that may provide input to the sound controller 18 may include a rough road detector, which could be based on data from the suspension system. If the rough road detector detects that the road is rough, the sound controller 18 may activate the stress operating mode, or the high-stress operating mode, to alert the driver. The sound controller 18 may be able to determine whether the road is slightly rough or very rough, in some embodiments, based on the signal received from the rough road detector, and activate a mild-stress operating mode or high-stress operating mode in response to the signal received from the rough road detector. Based on the operating mode selected or activated, the sound controller 18 would cause the acoustical damping device 16 to output a full canceling output 22, a reduced canceling output 22, a harmonic output 26, and/or an atonal output 26 as explained in other paragraphs herein. In addition, a vehicle entertainment system 28 may be activated to lower the volume of the vehicle entertainment system or play an alert message or alert sound in the mild-stress operating mode or the high-stress operating mode. In the alternative, if the rough detector does not indicate roughness, the sound controller 18 may activate the calm driving mode, if no other environment sensors 24 cause the stress or high-stress operating modes to be selected.

Yet another environment sensor 24 that may provide input to the sound controller 18 may include a speed sensor. If the speed sensor provides a signal to the sound controller 18 indicating that the vehicle is traveling above a predetermined threshold speed, for example, over the speed limit, the sound controller 18 may activate the stress operating mode or high-stress operating mode, to alert the driver as explained above and below.

Still another environment sensor 24 that may provide input to the sound controller 18 may include a camera. The camera could be used in a variety of ways, such as to detect objects in the road, to detect traffic, or to detect road signs or roads. The sound controller 18 could be configured to select one of the operating modes based on certain observances by the camera, which could be pre-programmed into the sound controller 18.

Another environment sensor 24 that may provide input to the sound controller 18 may include a global-positioning-system (GPS). The GPS may be an on-board vehicle navigation system having an internally stored electronic map. The vehicle's position is used to place the vehicle 10 on a map. The map can indicate the type of road surface on which the vehicle is being operated, the posted speed limit for the road, nearby hazards, sharp turns, etc. Moreover, an inputted navigation route may be processed to establish anticipated vehicle road conditions and anticipated maneuvers.

The GPS may provide map data and route data to the sound controller 18, and the sound controller 18 may activate the stress operating mode, or a high-stress operating mode, to alert the driver when the driver is approaching a turn on his/her route, or when the driver is driving in a dangerous area, such as beside a lake or a cliff or when approaching a curve or intersection. In the alternative, if the map data shows that the area is safe, and if the route data indicates no approaching turns, then the sound controller 18 would not activate a stress operating mode, and instead, the sound controller 18 may activate the calm driving mode, if no other environment sensors 24 cause the stress or high-stress operating modes to be selected.

Yet another environment sensor 24 that may provide input to the sound controller 18 may include a radar detector. If the radar detector detects police radar, for example, the sound controller 18 could be configured to activate the stress operating mode, or the high-stress operating mode, to alert the driver.

Still another environment sensor 24 that may provide input to the sound controller 18 may include a driver drowsiness sensor. If the driver drowsiness sensor detects that the driver is drowsy, the sound controller 18 may activate the stress operating mode, or the high-stress operating mode, to alert the driver.

Another environment sensor 24 that may provide input to the sound controller 18 may include a traffic detector. If a traffic detector detects that a traffic jam lies ahead, the sound controller 18 may activate the stress operating mode, or the high-stress operating mode, to alert the driver, by way of example.

Yet another environment sensor 24 that may provide input to the sound controller 18 may include one or more weather condition sensors. If poor weather for driving is detected, such as freezing temperatures and/or water, snow, or ice on the roads or in the air are detected, the sound controller 18 may activate the stress operating mode, or the high-stress operating mode, to alert the driver, by way of example.

It should be understood that the apparatus 14 or vehicle sound system 12 could use any combination or all of the environment sensors 24 described above, or any other environment sensors not described herein in addition or in the alternative. Further, the environment sensors 24 may be separate units, or some or all of them could be housed in a single sensor unit. For example, the GPS and traffic indicator may be part of a single apparatus.

Thus, in one embodiment, for example, a camera, a GPS, and a driver drowsiness detector could be used together as the environment sensors 24. The sound controller 18 could be configured to receive data from all three environment sensors 24 and select an operating mode based on the data received from each of them. If all of the sensors indicated easy, safe driving conditions, the sound controller 18 would select the calm operating mode and allow the acoustical damping device 16 to generate the noise canceling output 22 to dampen the background noise to full extent of the capability of device 16. If the sound controller 18 detects the presence of driving conditions under which heightened attention would be a benefit, however, the sound controller 18 would be configured to select and activate the mild-stress or high-stress operating mode, which could operate as described elsewhere herein. It should be understood that the mild-stress and high-stress operating modes could be designed to change the vehicle sound in any desirable way as described herein, and they are not limited to any particular embodiment. For example, in some embodiments, the mild-stress operating mode could cause an alteration in the sound canceling output so as to reduce dampening, but not eliminate it, while in other embodiments, it may be desirable to eliminate the noise canceling output 22 in the mild-stress operating mode, but the elimination could be saved for the high-stress operating mode, if desired. Further, the sound controller 18 may cause the acoustical damping device 16 to generate a signal to cause the atonal sounds and/or harmonic sounds to amplify the vehicle noise, lower the entertainment system 28 volume, or play an alert sound or message in either of the mild-stress or high-stress operating modes, as desired.

As stated above, the system 12 and apparatus 14 may include three, four, or any other number of desired operating modes without falling beyond the spirit and scope of the present invention. For example, the sound controller 18 may define a calm operating mode, a mild-stress operating mode, and a high-stress operating mode. In the mild-stress operating mode, the sound controller 18 could cause the acoustical damping device 16 to alter the noise canceling output 22 to lower the level of damping, without eliminating damping, for example. In some forms of the inventive apparatus 14 and system 12, the sound controller 18 could be configured to eliminate the noise canceling output 22 to eliminate damping in the high-stress operating mode. The sound controller 18 could be further configured to cause the acoustical damping device 16 to generate a signal to cause an atonal or harmonic sound output, in the high-stress operating mode, as explained above, to raise driver awareness. For example, the harmonic sound tones could be played to change the driver's perception of the environment.

In some embodiments, in the high-stress operating mode, the sound controller 18 may be configured to generate an entertainment system signal to the vehicle entertainment system 28 to lower the volume of existing sound from the vehicle entertainment system 28 playing over vehicle speakers. Further, the sound controller 18 could send the entertainment system 28 a signal to cause the playing of an alert message over the vehicle speakers in place of the existing entertainment system sound. For example, if the entertainment system 28 had been playing music, the sound controller 18 could cause the entertainment system 28 to lower or stop the music sound, and/or to play an alert sound or message, such a beeping sound or an audio message. The audio message could play aloud, for example, “Warning: the road is icy; proceed with caution.” The warning sound or message could be played while the music is still playing, or the music could be stopped before playing the alert sound or message.

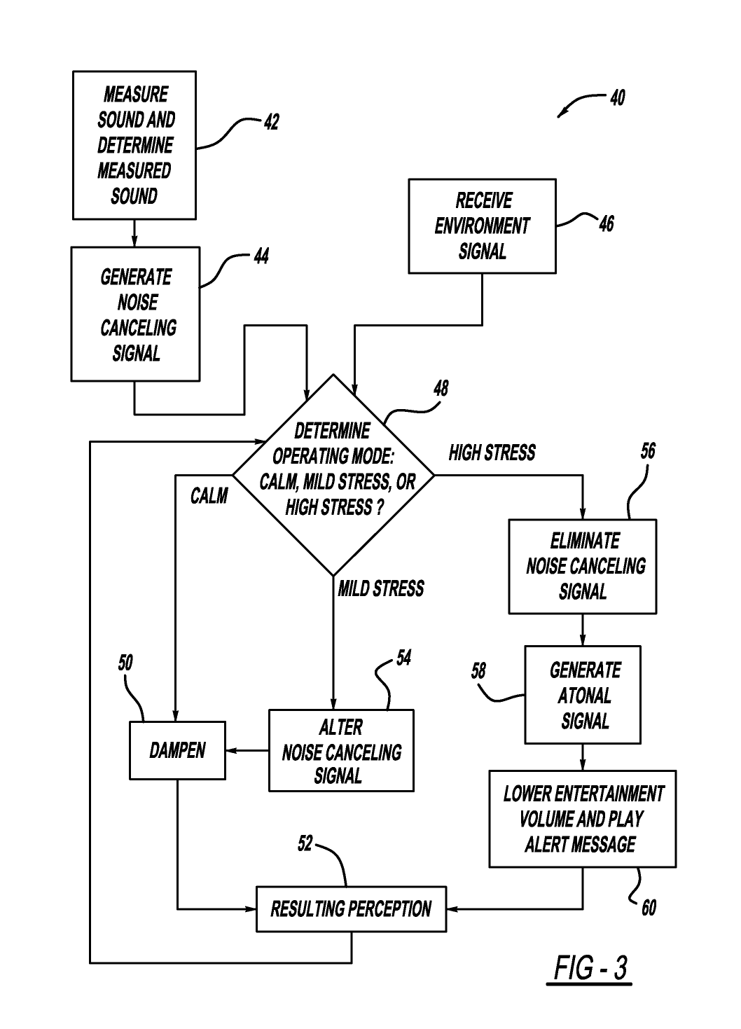

Now with reference to FIG. 3, a flow diagram is illustrated to show an example logic diagram for a method 40 that may be employed, for example, by the apparatus 14, to determine when to select and activate a calm operating mode, a mild-stress operating mode, and a high-stress operating mode. In this example, the method 40 includes a step 42 of determining a measured sound of the background noise in a vehicle. The measured sound may include the road noise, the noise from the vehicle powertrain and other components, as well as any outside noises. To dampen the background noise, the method 40 includes a step 44 of generating a noise canceling signal.

Simultaneously, or before or after, the method 40 includes a step 46 of receiving an environment signal from an environment sensor 24. The environment signal may be received automatically, without any user input, in some embodiments.

Based on predetermined patterns and/or programmed information, the method 40 includes a step 48 of determining the vehicle operating mode. The operating mode may be determined to be a calm operating mode, a mild-stress operating mode, or a high-stress operating mode, in this embodiment. It should be understood, however, that there could be any number of operating modes, so long as there are at least two different operating modes, without falling beyond the spirit and scope of the present invention.

If the operating mode is determined to be a calm operating mode, the method 40 includes a step 50 of dampening the sound within the vehicle 10. This occurs because nothing is done to alter the step 44 of generating the noise canceling signal. Thus, the background noise is dampened 50 and the resulting perception 52 occurs. In the calm driving mode, the resulting perception 52 is a calm, comfortable, and quiet driving environment.

If the operating mode is determined to be a mild-stress operating mode, the method 40 includes a step 54 of altering the noise canceling signal. When the noise canceling signal is altered, it no longer dampens the background noise to the fullness of the acoustical damping device's 16 capability, but instead, the background noise is canceled to only a partial extent. Thus, a step 50 of damping occurs, but it is only a partial damping after the step 54 of altering the noise canceling signal. Therefore, the resulting perception 52 occurs, which in the mild-stress operating mode is a feeling of mild-stress, wherein there is some road noise and some noise from the powertrain and other vehicle components present within the vehicle.

If the operating mode is determined to be a high-stress operating mode, the method 40 includes a step 56 of eliminating the noise canceling signal completely. Therefore, the vehicle 10 operates as though it has no acoustical damping device 16, and the road noises and vehicle noises are therefore present within the vehicle. The method 40 may also include a step 58 of generating an atonal signal and a step 60 of lowering the entertainment system volume and playing an alert message, as described elsewhere herein. Thus, the resulting perception 52 occurs, wherein the driver feels a higher amount of stress because of the atonal sounds, lowered entertainment system volume, and an alert message. In some embodiments, the method 40 also includes playing harmonic tones in the high-stress operating mode, such that background noise may be increased, or other sounds may be played that do not cancel the background noise.

Therefore, in one scenario, on a straight, uneven country road, a calm operating mode may be determined, allowing sound dampening to be maximized, such that a driver hears a minimal amount of road noise and focuses on watching for obstacles such as deer.

In another scenario, when a vehicle 10 is traveling on a winding road over the speed limit, a mild-stress operating mode may be determined, causing damping to be reduced, such that a driver hears more of the road noise and engine noise and perceives that he/she is moving at a high rate of speed, even if he/she is not driving at as high of a rate as the noise suggests.

In a third scenario, when a vehicle 10 is traveling in an area with dangerous curves, a high-stress operating mode may be determined, causing the active sound dampening system 12 to introduce a subliminal harmonic sound, such as a slightly atonal sound, to put the driver more “on edge,” so that the driver will be highly attentive.

Other examples of environment signals that may cause the calm operating mode to be selected include signals that indicate that a relatively straight road is being traveled, weather conditions are good, traffic is light, and/or no upcoming turns or hazards are approaching. In such a case, sound damping is maximized.

Additional examples of environment signals that may cause the mild-stress operating mode to be selected include signals that indicate that the vehicle 10 is traveling in a city, traffic is moderate, traffic lights are present, pedestrians are present, the road is under construction, and/or a turn is approaching on the driver's programmed route. In such a case, sound damping may be reduced or eliminated.

Examples of environment signals that may cause the high-stress operating mode to be selected include signals that indicate that the vehicle 10 is operating in high traffic, poor weather (including snow, ice, and/or rain), along windy and/or difficult roads, and/or next to hazards. In such a case, sound damping may be reduced or eliminated, subliminal sounds may be emitted, and the entertainment sound system volume may be lowered or muted. Further, an alert sound or message may be played.

In some embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the method 40, and any parts of the system 12 and apparatus 14, described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

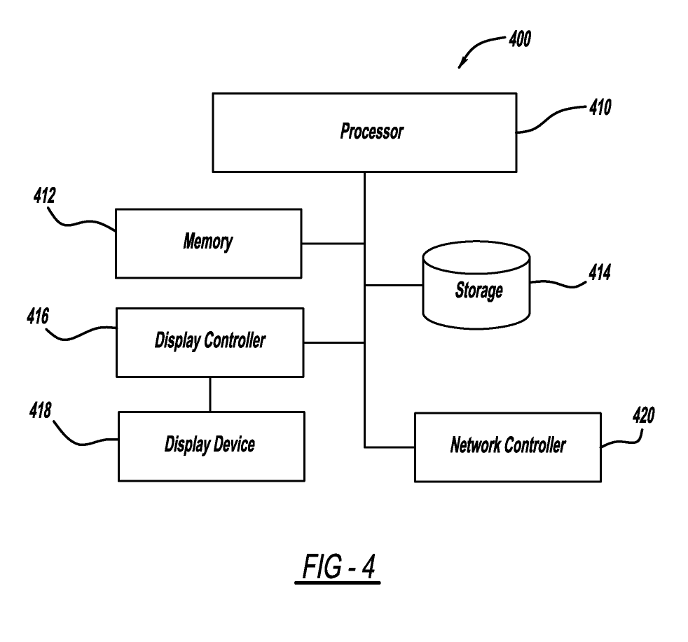

For example, one or more computer systems may be used. One exemplary system is provided in FIG. 4. The computer system 400 includes a processor 410 for executing instructions such as those described in the methods discussed above. The instructions may be stored in a computer readable medium such as memory 412 or storage devices 414, for example a disk drive, CD, or DVD. The computer may include a display controller 416 responsive to instructions to generate a textual or graphical display on a display device 418, for example a computer monitor. In addition, the processor 410 may communicate with a network controller 420 to communicate data or instructions to other systems, for example other general computer systems. The network controller 420 may communicate over Ethernet or other known protocols to distribute processing or provide remote access to information over a variety of network topologies, including local area networks, wide area networks, the Internet, or other commonly used network topologies.

As a person skilled in the art will readily appreciate, the above description is meant as an illustration of the principles of the invention. This description is not intended to limit the scope or application of the invention in that the invention is susceptible to modification, variation and change, without departing from spirit of the invention, as defined in the following claims.

We claim:

1. An apparatus for controlling sound within a motor vehicle, the apparatus comprising:
an acoustical damping device operable to determine a measured sound, the acoustical damping device operable to output a noise canceling signal to a vehicle audio system to dampen the measured sound; and
a sound controller operably coupled to the acoustical damping device, the sound controller configured to automatically receive an environment signal from an environment sensor, the sound controller configured to determine an operating mode of the vehicle based on the environment signal, the operating mode being selectable from an operating mode list that includes a first operating mode and a second operating mode, wherein
the sound controller is configured to cause alteration of the noise canceling signal and a reduction in damping in the second operating mode with respect to the first operating mode.

2. The apparatus of claim 1, wherein the operating mode list further includes a third operating mode, the sound controller being configured to eliminate the noise canceling signal to eliminate damping in the third operating mode.

3. The apparatus of claim 2, wherein in the third operating mode, the sound controller is configured to cause the acoustical damping device to generate an atonal signal, the atonal signal being configured to cause an atonal sound to raise driver awareness.

4. The apparatus of claim 3, wherein in the third operating mode, the sound controller is configured to generate an entertainment system signal to the vehicle entertainment system, the entertainment system signal configured to lower volume of existing sound from the entertainment system playing over vehicle speakers.

5. The apparatus of claim 4, wherein in the third operating mode, the entertainment system signal is configured to cause the playing of an alert message over the vehicle speakers in place of the existing sound.

6. The apparatus of claim 2, wherein in the third operating mode, the sound controller is configured to cause the acoustical damping system to generate a harmonic tone signal, the harmonic tone signal being configured to cause harmonic sound tones to change a driver's perception of environment.

7. An apparatus for controlling sound within a motor vehicle, the apparatus comprising:
an acoustical damping device operable to determine a measured sound within the vehicle, the acoustical damping device operable to output a noise canceling signal to a vehicle audio system to dampen the measured sound; and
a sound controller operably coupled to the acoustical damping device and to a vehicle entertainment system, the sound controller configured to automatically receive an environment signal from an environment sensor, the sound controller configured to determine an operating mode of the vehicle based on the environment signal, the operating mode being selectable from an operating mode list that includes a high-stress operating mode, a mild-stress operating mode, and a calm operating mode, wherein the environment sensor is selected from at least one of the following: an external object detector, a rough road detector, a camera, a global-positioning-system (GPS) device, a radar detector, a speed sensor, a traffic detector, a weather detector, and a driver drowsiness sensor, wherein
in the high-stress operating mode, the sound controller is configured to eliminate the noise canceling signal and eliminate damping, the sound controller is configured to cause the acoustical damping device to generate an atonal signal, the atonal signal being configured to cause an atonal sound to raise driver awareness, and the sound controller is configured to generate an entertainment system signal to the vehicle entertainment system to lower the volume of existing sound from the entertainment system playing over vehicle speakers and play an alert message over the vehicle speakers;
in the mild-stress operating mode, the sound controller is configured to cause alteration of the noise canceling signal and a reduction in damping; and
in the calm operating mode, the sound controller is configured to refrain from altering the noise canceling signal and refrain from reducing damping.

8. The apparatus of claim 7, the environment signal being a first environment signal and the environment sensor being a first environment sensor, the sound controller configured to automatically receive a second environment signal from a second environment sensor, wherein the second environment sensor is selected from at least one of the following: a external object detector, a rough road detector, a camera, a global-positioning-system (GPS) device, a radar detector, a speed sensor, a traffic detector, a weather detector, and a driver drowsiness sensor, the sound controller being configured to determine the operating mode of the vehicle based on the first and second environmental signals.

9. The apparatus of claim 8, wherein the first environment sensor is a camera and the second environment sensor is a GPS, the sound controller configured to automatically receive a third environment signal from a driver drowsiness detector and determine the operating mode of the vehicle based on the first, second, and third environment signals.

10. A sound control system for controlling sound within a motor vehicle, the sound control system comprising:
an environment sensor operable to measure a parameter of the environment and output an environment signal;
a sound controller operably coupled to the environment sensor, the sound controller configured to automatically receive the environment signal and determine an operating mode of the vehicle based on the environment signal, the operating mode being selectable from an operating mode list that includes a first operating mode and a second operating mode;
an acoustical damping device operably coupled to the sound controller, the acoustical damping device operable to measure sound and determine a measured sound, the acoustical damping device operable to output a noise canceling signal to dampen the measured sound; and
a vehicle audio system operable to receive the noise canceling signal from the acoustical damping device and emit the noise canceling sound to dampen noises within the vehicle, wherein
the sound controller is configured to cause alteration of the noise canceling signal and a reduction in damping in the second operating mode with respect to the first operating mode.

11. The sound control system of claim 10, wherein the operating mode list further includes a third operating mode, the sound controller being configured to eliminate the noise canceling signal and eliminate damping in the third operating mode.

12. The sound control system of claim 11, wherein in the third operating mode, the sound controller is configured to cause the acoustical damping device to generate an atonal signal, the atonal signal being configured to cause an atonal sound to raise driver awareness, the sound controller is configured to generate an entertainment system signal to the vehicle entertainment system, the entertainment system signal configured to lower the volume of existing sound from the entertainment system playing over vehicle speakers and cause the playing of an alert message over the vehicle speakers in place of the existing sound.

13. The sound control system of claim 12, wherein the environment sensor is a camera and the environment signal is a first environment signal, the sound control system further comprising a GPS configured to generate a second environment signal to the sound controller and a driver drowsiness sensor configured to generate a third environment signal to the sound controller, the sound controller being configured to determine the operating mode of the vehicle based on the first, second, and third environment signals.

14. A method of controlling sound within a motor vehicle to increase driver awareness during certain driving conditions, the method comprising:
determining a measured sound within a vehicle;
generating a noise canceling signal to a vehicle audio system to dampen the measured sound;
automatically receiving an environment signal from an environment sensor;
determining an operating mode of the vehicle based on the environment signal, the operating mode being selectable from an operating mode list that includes a first operating mode and a second operating mode;
in the second operating mode, altering the noise canceling signal and reducing damping with respect to the first operating mode.

15. The method of claim 14, wherein the operating mode list further includes a third operating mode, the method further comprising, in the third operating mode, causing an atonal sound to increase driver awareness and altering or eliminating the noise canceling signal to reduce damping.

16. The method of claim 15, further comprising lowering volume of existing sound from an entertainment system playing over vehicle speakers in the third operating mode.

17. The method of claim 16, further comprising causing the playing of an alert message over the vehicle speakers in the third operating mode.

18. The method of claim 15, further comprising causing the playing of harmonic tones that are configured to change a driver's perception of environment in the third operating mode.

19. The method of claim 15, wherein the step of automatically receiving an environment signal comprises receiving the environment signal from at least two of the following: a external object detector, a rough road detector, a camera, a global-positioning-system (GPS) device, a radar detector, a speed sensor, a traffic detector, a weather detector, and a driver drowsiness sensor.

20. A machine-readable medium that provides instructions, which when executed by a machine, cause the machine to perform operations comprising:
determining a measured sound within a vehicle;
generating a noise canceling signal to a vehicle audio system to dampen the measured sound;
automatically receiving an environment signal from an environment sensor;
determining an operating mode of the vehicle based on the environment signal, the operating mode being selectable from an operating mode list that includes a first operating mode and a second operating mode;
in the second operating mode, altering the noise canceling signal and reducing damping with respect to the first operating mode.
